(19) United States
(12) Patent Application Publication
(10) Pub. No.: US 2009/0043857 A1
(43) Pub. Date: Feb. 12, 2009

(54) SYSTEMS AND METHODS FOR SENDING AND RECEIVING A TASK VIA INSTANT MESSAGING

(75) Inventor: Andrew Rodney Ferlitsch, Camas, WA (US)

Correspondence Address: AUSTIN RAPP & HARDMAN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/836,659

(22) Filed: Aug. 9, 2007

(51) Int. Cl. G06F 15/16

(52) U.S. Cl. 709/206

(57) ABSTRACT

A method for receiving a task via an Instant Messaging (IM) service is described. The device is connected to the IM service. A task initiation instant message is received. A response to the task initiation instant message is sent. The response includes instructions on how to send a task to the device using the IM service. The instructions are independent of an IM provider that provides the IM service. A command is received to execute the task at the device.

### TECHNICAL FIELD

The present disclosure relates generally to computers and computer-related technology. More specifically, the present disclosure relates to systems and methods for sending and receiving a task via instant messaging.

### BACKGROUND

Instant messaging refers to the process of exchanging text messages between two or more people. Instant messaging differs from email in that conversations happen in real time. The parties in the conversation typically see each line of text right after it is typed (line-by-line). Also known as a “chatting,” instant messaging has become very popular for both business and personal use.

An instant messaging (hereinafter, “IM”) client may be used to send instant messages to and receive instant messages from other users. Many different IM clients are known to those skilled in the art. Examples of IM clients include Yahoo! Messenger, MSN Messenger, America Online's Instant Messenger (AIM), and a variety of others including those based on the Jabber Open XML Protocol. An IM client may also include profile information relating to a user. Such profile information may include the user's name, address, etc.

As previously mentioned, instant messaging occurs in real time while email communications may experience a delay before the intended parties receive the communication. However, email has been used to send communications to devices, such as printers. For example, a user may email a print job to a printer with the file to be printed attached to the email message. The user may also include settings for the print job in the email (how many copies to print, print in black/white or color, etc.) Unfortunately, the user must have prior knowledge of the printer's capabilities in order to be able to specify settings for the print job.

Benefits may be realized by connecting devices, such as printers, to IM services. Profile information for the device may be stored by the IM services that may be accessible to a user. Thus, benefits may be realized from systems and methods for sending and receiving a task, such as a print job, via instant messaging.

### BRIEF DESCRIPTION OF THE DRAWINGS

FIG. 1 is a block diagram illustrating an exemplary operating environment where the present systems and methods may be practiced;

FIG. 2 is one embodiment of an Instant Messaging (IM) client;

FIG. 3 is one embodiment of a method for receiving a print job via an IM service;

FIG. 4 is a thread diagram illustrating one embodiment of connecting to an IM service;

FIG. 5 is a thread diagram illustrating one embodiment of registering a Multi-Functional Printing (MFP) device as a contact;

FIG. 6 is a flow diagram illustrating one embodiment of a method for sending a task to a device;

FIG. 7 is a thread diagram illustrating a further embodiment of a client initiating contact with a MFP device;

FIG. 8 is a flow diagram illustrating a method for submitting a print job using an embedded device web page;

FIG. 9 is a flow diagram illustrating a method for printing a print job using an IM application to submit the print job;

FIG. 10 is a block diagram illustrating the major hardware components typically utilized with embodiments herein; and

FIG. 11 is a network block diagram illustrating one possible environment in which the present systems and methods may be implemented.

### DETAILED DESCRIPTION

A method for receiving a task via an Instant Messaging (IM) service is described. The device is connected to the IM service. A task initiation instant message is received. A response to the task initiation instant message is sent. The response includes instructions on how to send a task to the device using the IM service. The instructions are independent of an IM provider that provides the IM service. A command is received to execute the task at the device.

The device is a Multi-Functional Printing (MFP) device. The device may be registered with the IM service. An email address assigned to the device may be provided. A unique user name assigned to the device may also be provided. A request is received to add the device to a contact list. The response to the task initiation instant message may include a hyper-text transfer protocol link to an embedded web page associated with the device. A document to print may be submitted to the device over one or more firewalls via the embedded web page.

The response to the task initiation instant message may include instructions on how to upload a document to print to the device through the IM service. The response to the task initiation instant message may further include instructions on how to specify task settings in an instant message.

A method for sending a task via an Instant Messaging (IM) service is also described. A task initiation message is sent to a device that is included in a contacts list. A response to the task initiation message is received. The response includes an http link to a web page associated with the device and instructions on how to use the IM service for sending the task to the device. The instructions are independent of an IM provider that provides the IM service.

A file to be printed by the device may be uploaded through the IM service. A textual description of settings for the task may be provided in an instant message. An uploaded file to be printed and a textual description of settings for the task may be sent to the device through the IM service. The http link may be selected to request an embedded web page associated with the device. A file to be printed by the device and settings for the task are submitted via a web browser that displays an embedded web page associated with the device.

A printing device that is configured to receive a print job via an Instant Messaging (IM) service is also described. The printing device includes a processor and memory in electronic communication with the processor. Instructions are stored in the memory. The printing device is connected to the IM service. A print job initiation instant message is received. A response to the print job initiation instant message is sent. The response includes instructions on how to send a print job to the printing device using the IM service. The instructions are independent of an IM provider that provides the IM service. A command to execute the print job is received. The print job is executed at the printing device.

A computer-readable medium including executable instructions is also described. A device is connected to an Instant Messaging (IM) service. A task initiation instant message is received. A response to the task initiation instant message is sent. The response includes instructions on how to send a task to the device using the IM service. The instructions are independent of an IM provider that provides the IM service. A command is received to execute the task. The task is executed at the device.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

One way of communicating print jobs to a device, such as a Multi-Functional Printer (MFP), is via email print. This allows direct printing from a wide variety of computing devices and locations without having the need for a printer driver to be installed. However, some social studies are showing that email usage is declining with people under the age of 18, being replaced by instant message forms of communication. Specifically, some surveys of 13-17 year olds, showed that only 20% of the people communicate using email. More dramatically, ⅓ of this age group relied solely on IM for electronic communication, in comparison to only 11% of adults.

In many conventional printers, one can direct a document to print using email. Generally, in these printers, one sends an email to the email address assigned to the printer. Usually, the email includes an attachment that the user desires to print. In some systems, the attachment is printed according to the printer's default settings. In other systems, the user has some means to specify a limited set of print settings, such as specifying them in the subject line or in the body of the email message. However, directing a document to print using email has limitations. First, the user must have prior knowledge of the printer's capabilities. Second, the user must have prior knowledge of the means to specify the print settings (e.g., keyword/setting pairs).

One solution to the above problem is for the printer to provide end-users with an embedded device web page to use as an interface for directing a document to the printer. Generally, the user would connect to the printer via a web browser. The printer would either return the printer's direct print web page or a home page. In the latter case, the user would traverse from the home page to the direct print web page. The web page generally has a means to browse/specify a local file for uploading to the printer. The local file may then be printed. The web page generally also has a means to specify a limited set of print options. Providing end-users with an embedded device web page has a further advantage in that the web page includes a predefined print user interface (UI) settings interface. In other words, the user may not need to have prior knowledge of how to specify print settings. However, providing an embedded device web page still has limitations. For example, the user needs to have a full browser capability. In addition, the user needs to have a desire to use the web browser as the main interface to the printer.

The present systems and methods provide a means for a user to implement an Instant Messenger application to send a print job to a printer via the Instant Messenger protocol. Additionally, the present systems and methods provide a means for the user to specify print settings for the print job.

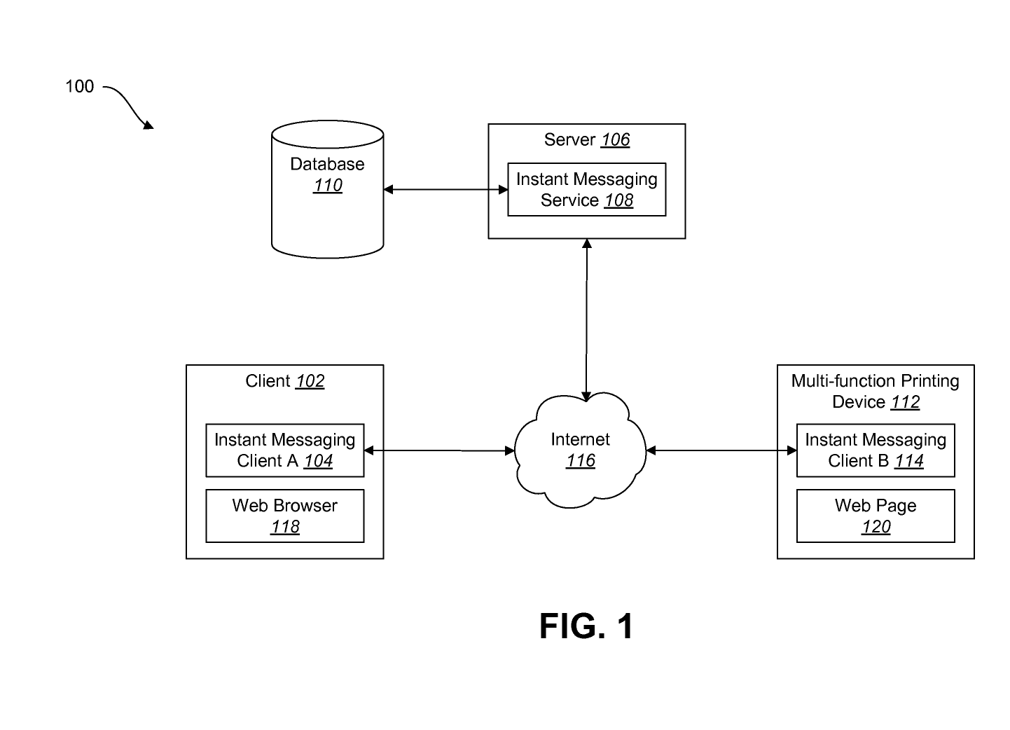

FIG. 1 is a block diagram illustrating an exemplary operating environment 100 where the present systems and methods may be practiced. A Multi-Functional Printer (MFP) device 112 may be connected to the Internet 116. The MFP device 112 may provide one or more imaging capabilities, such as: printing, copying, scanning, filing, faxing, converting, publishing, displaying, etc. The device 112 may include an Instant Messaging (IM) client B 114 and an embedded web page 120. The IM client B 114 may facilitate the MFP device 112 to send/receive instant messages to/from other devices over the Internet 116. The instant messages may be sent or received via an IM service 108, that may be provided by IM providers such as AOL®, Yahoo®, MSN®, etc. The IM service 108 may be included within a server 106. The server may not be a local server, but rather a wide area server that utilizes an IM service 108 that is provided by a well known IM provider. The present systems and methods may be deployed through an existing IM service 108. In other words, an existing IM provider does not have a need to make changes to an existing IM service 108 in order to deploy the present systems and methods. In addition, an existing IM provider does not need to make modifications in order to integrate the present systems and methods. The embedded web page 120 may provide a UI that a user may use to provide a print job to the MFP device 112. The user may also interface with the embedded web page 120 to specify settings for the print job.

Additionally, the exemplary operating environment 100 may include one or more clients 102. The client 102 may be a thin client or a thick client. A thin client may be a computing device which depends primarily on a central server for processing activities. A thick client may do as much processing as possible and passes only data for communications and storage to the central server.

The client 102 may include an IM client A 104 and a web browser 118. The IM client A 104 may be used to send/receive instant messages to/from other devices, for example the MFP device 112, over the Internet 116. Instant messages sent from the client 102 or the MFP device 112 may be routed to the IM service 108 that is stored on a server 106. The server 106 may access a database 110 that stores information relating to each device implementing an IM client. The web browser 118 may display the embedded web page 120 to the user.

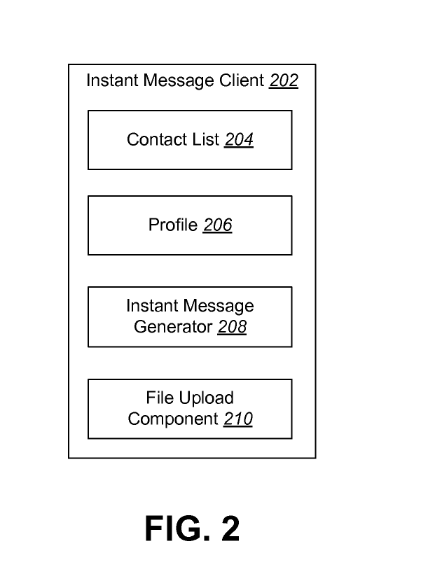

FIG. 2 is one embodiment of an IM client 202. The IM client 202 includes a contact list 204, a profile 206, an instant message generator 208 and a file upload component 210. The contact list 204 may be a list of other users that are using an IM client. In another embodiment, the contact list 204 includes the identification of certain computing devices, printers, etc. The contact list 204 may also be referred to as a “buddy list.” A user may select another user on the contact list 204 and send an instant message to the selected user.

The profile 206 includes information relating to each user included on the contact list 204. The profile 206 may include the name, address, birthday, etc. of each user on the list 204. The profile 206 may also include information relating to a device that is included on the contact list 204. For example, if a printing device was included on the contact list 204, the profile 206 may include the identification of the device, the default printer settings of the device, etc.

The instant message generator 208 may generate an instant message area in which a user may enter text that is sent to another user or device as an instant message. The file upload component 210 allows the user to also attach files to an instant message. In other words, a user may send a file to another user or device in an instant message.

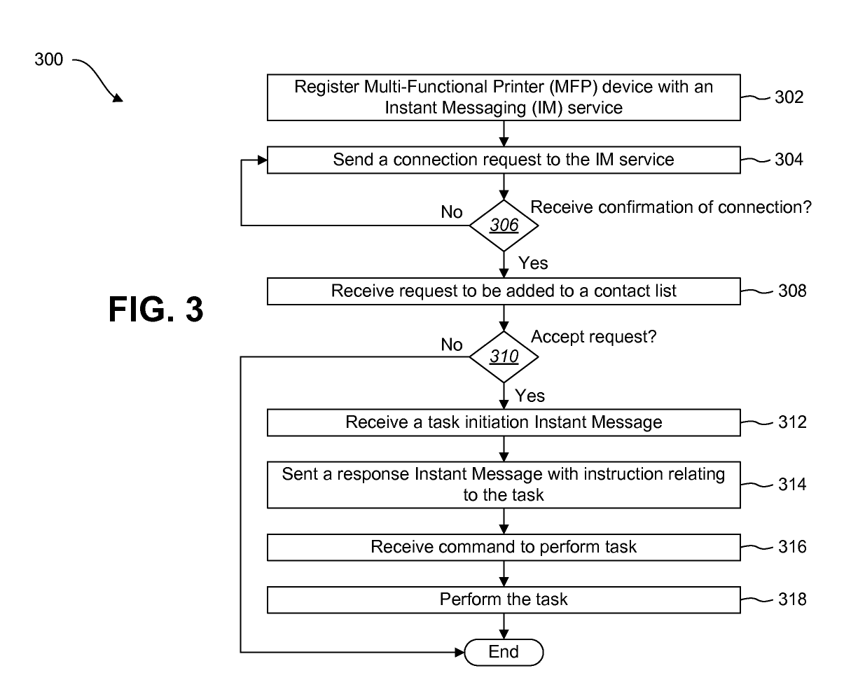

FIG. 3 is one embodiment of a method 300 for receiving a print job via an IM service. The method 300 may be implemented by an MFP device. In one embodiment, the MFP device registers 302 with an IM service. Typically, this may be done by an administrator or operator via the MFP's administrative interface. Generally, the administrative interface is accessible via an operational (front) panel, an embedded web page or a printer administration utility (PAU) communicatively coupled with the MFP device.

Registering 302 the device with the IM service may include assigning an email address to the MFP device if one has not already been assigned. In addition, a user name is also assigned to the MFP device. In one embodiment, the user name is unique to the IM service. Further, an avator icon may be selected that is representative of the MFP device. An IM account may be created with the IM service. Creating the IM account may include providing the assigned email address and unique user name to the IM service, providing the avator icon and completing a profile that includes information relating to the MFP device.

The information included in the profile may convey printer specific information to an end-user such as the type and capabilities of the MFP device, the location of the MFP device, links to the MFP's embedded direct web page and textual information on how to use the MFP device. The profile may be stored by the IM service as part of the registration of the MFP device. In one embodiment, the profile is stored in the database 110 of FIG. 1.

A connection request may be sent 304 to the IM service. A determination 306 is made as to whether a confirmation to the connection request has been received. If no confirmation is received, a connection request 304 is sent again to the IM service until a confirmation is received.

If it is determined 306 that a confirmation has been received, a request to be added to a contact list may be received 308. The request may be sent from a client that is requesting the MFP device to be included on the contact list of the IM client on the client. It is determined 310 whether or not to accept the request to be added to the contact list. If it is determined to not accept the request, the method 300 ends.

If it is determined to accept the request, a task initiation instant message may be received 312. The task initiation instant message may include text or some other form of information requesting the MFP device to perform a certain task. The task may include a print job, a scan, a fax, etc. A response instant message with instructions relating to the task may be sent 314. The instructions may instruct a user how to send details regarding the task. For example, the instructions may instruct the user how to attach a file to an instant message if the file is to be printed. The instructions may also instruct the user how to specify settings for the task, such as printer settings.

A command to perform the task may be received 316. The task may be performed 318. Further details regarding certain steps of the method 300 are provided below.

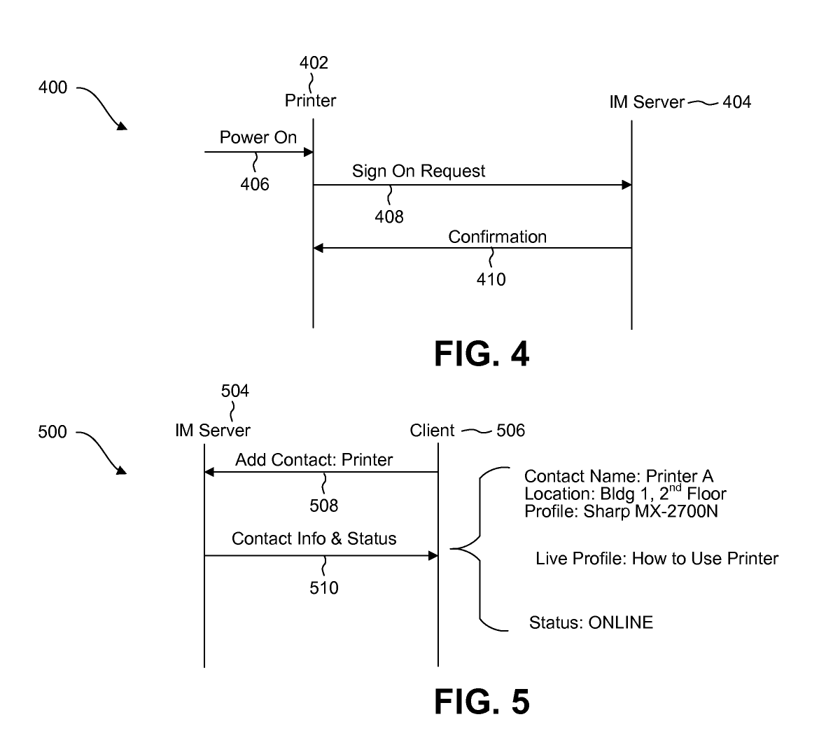

FIG. 4 is a thread diagram 400 illustrating one embodiment of connecting to an IM service 404. After a device, such as the MFP device 402, has registered 302 with the IM service, it may automatically sign-on with the IM service whenever the MFP device 402 is powered on 406 or changes from an offline status to an online status. Thus, when the MFP device 402 is powered off or is inoperable (e.g., paper jam), the device 402 may appear to an IM client on another device as having an OFFLINE status. As part of connecting to the IM service 404, the MFP device 402 may send a sign-on request 408 to the IM service 404. The IM service 404 may send a confirmation 410 message back to the MFP device 402 confirming that the device is signed on to the IM service 404.

FIG. 5 is a thread diagram 500 illustrating one embodiment of registering an MFP device as a contact. Once the MFP device is registered 302 with the IM service, other devices, such as the client 102, that use the IM service may add the MFP device to their respective contact lists. In other words, other devices may add the MFP device as an IM contact. An IM contact is typically referred to as a “buddy”, and the MFP device may be added to the other device's contact list (i.e., “buddy list). This may be accomplished by a client 506 sending an add contact request 508 to the IM service 504. The IM service 504 may notify the MFP device that the client 508 is requesting to add the MFP device to it's (the client 508) contact list.

The MFP device may accept or reject adding itself to the contact list of the client by one or more means. For example, the MFP device may always accept the add contact request 508. This may occur if the MFP device is a public device. In this embodiment, the MFP device automatically accepts the add request 508. In another embodiment, the MFP device may check the contact information of the client 506 sending the add request 508. The MFP device may determine if the client 506 is within an organization (e.g., a company) where the MFP device resides. In a further embodiment, the MFP device checks the contact information of the client 506 against a list of predefined contacts that may be accepted. Further, the IM service 504 may forward the add request 508 to an administrator, who makes the determination to accept or reject the add request 508 sent form the client 506.

In one embodiment, if the MFP device accepts adding itself to the client's 506 contact list, the user of the client 506 may be able to operate the MFP device. In addition, the profile of the MFP device may be viewable by the user of the client 506. If the add request 508 is accepted, the IM service 504 sends contact information and status 510 to the client 506. The contact information and status 510 may include the name, location, profile and online status of the MFP device. In addition, the contact information and status 510 may include a live profile which includes information on how to use and operate the MFP device.

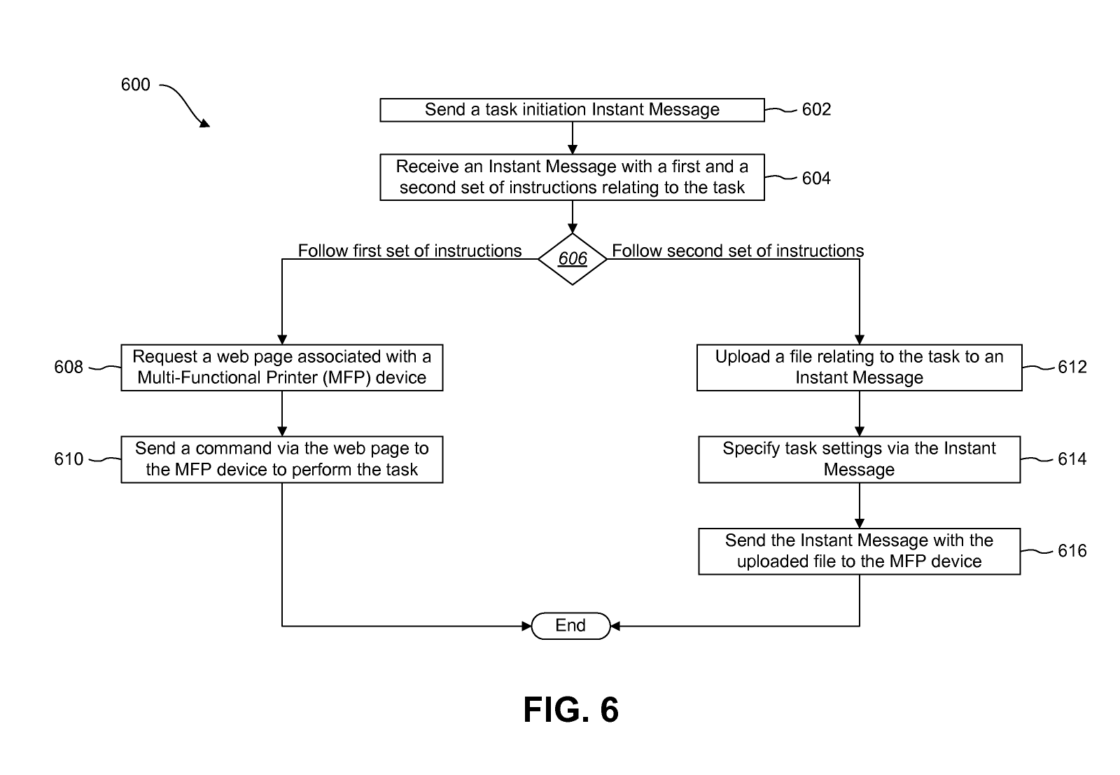

FIG. 6 is a flow diagram illustrating one embodiment of a method 600 for sending a task to a device, such as a MFP device. In one embodiment, the method 600 is implemented by the client 102. A task initiation instant message may be sent 602. An instant message may be received 604 that includes a first set of instructions and a second set of instructions relating to a task. A determination 606 is made as to which set of instructions to follow. If the first set of instructions is followed, a web page associated with the MFP device is requested 608. The web page may function as an interface between a user and the MFP device. A command may be sent 610 via the web page to the MFP device. The command may include a command to perform the task.

If the second set of instructions is followed, a file relating to the task may be uploaded 612 to an instant message. Settings for the task may be specified 614 via the instant message. For example, the setting for the task may be included as text within the instant message. The instant message may be sent 616 to the MFP device. In one embodiment, the instant message includes the uploaded file and the settings for the task.

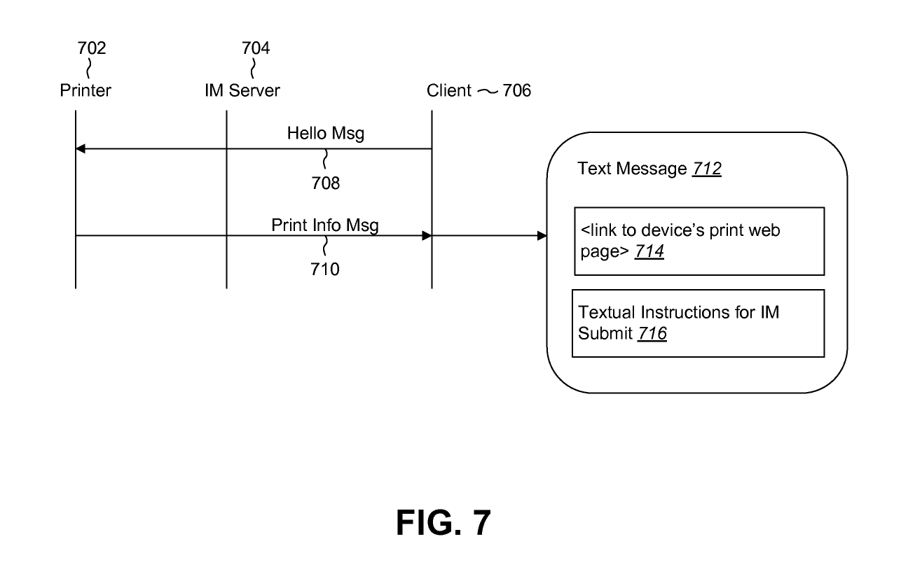

FIG. 7 is a thread diagram 700 illustrating a further embodiment of a client 706 initiating contact with an MFP device 702. A user may initiate a print job to the MFP device 702, via IM, by sending an initial instant message 708 to the MFP device 702. In one embodiment, the initial instant message 708 may include any textual content (including nothing)—which is ignored by the MFP device 702. In another embodiment, the initial instant message 708 is required to include a specific textual content, such as the word “Hello” or “Print”.

When the MFP device 702 receives the initial instant message 708, the device 702 responds with a response instant message 710 back to the client 706. The response instant message 710 may include a text message 712. The text message 712 may include a hyper-text transfer protocol (http) link 714 to the MFP's embedded web page. The text message 712 may also include textual instructions 716 on how to submit a task using IM. The textual instructions 716 may indicate how to submit a document for printing as well as instructions on how to specify printer settings. The instructions 716 may indicate how to upload the document to print to the MFP device 702 by using the IM client's file upload component 210. In addition, the textual instructions 716 may indicate how to specify print settings using text in the instant message. For example, print settings may be specified as a set of keyword/value pairs. An example may include “copies=2” which indicates that the printer settings should be set to print two copies of a document.

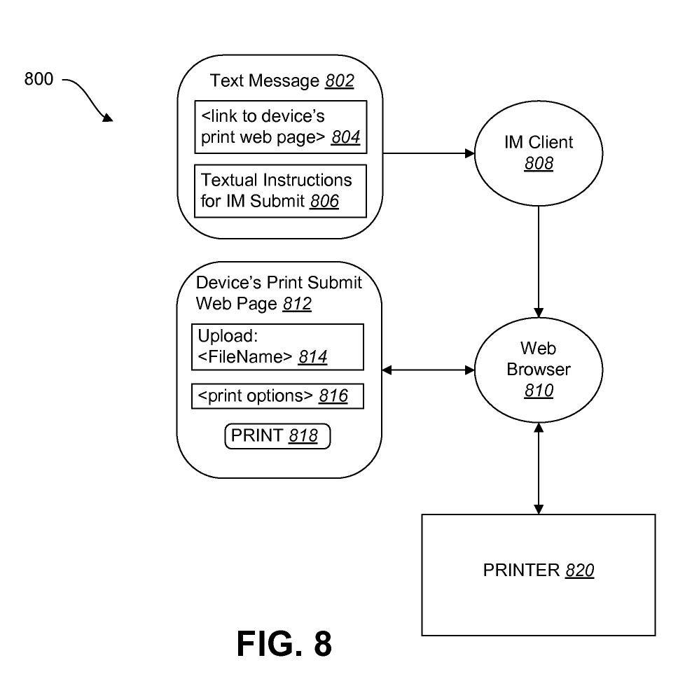

FIG. 8 is a flow diagram illustrating a method 800 for submitting a print job using an embedded device web page. As previously explained, a text message 802 sent from the MFP device 820 to an IM client 808 may include an http link 804 to the MFP's embedded direct print web page 812 along with textual instructions 806. The user of the IM client 808 may select the http link 804 and a web browser 810 on a client 102 (where the IM client 808 is running) may be activated. The web browser 810 may request the web page 812 from the MFP device 820 that is associated with the http address in the link 804. The MFP device 820 may return the embedded direct print web page 812 to the web browser 810. The user may interact with the MFP device 820 via the web page 812 for submission of the print job. The web page 812 may include a file upload area 814 that enables to user to upload a file that is to be printed. The web page 812 further includes a printer options 816 area that allows the user to specify printer settings. For example, the user may specify that two copies of the file should be printed. The user may select a “print” 818 button that sends a print command to the MFP device 820.

The method 800 of submitting a print job using an embedded device web page, allows printing across firewalls to occur. In one embodiment, firewalls generally exclude inbound requests that are initiated outside the firewall. However, organizations may make an exception for protocols used for personal communications, such as email and IM. In one embodiment, channels are left open in the firewall for unsolicited inbound messages initiated from protocols for personal communications.

In addition, communication head-end begins at an instant message interface. Further, the method 800 allows for direct printing without a web interface. In other words, no Uniform Resource Locator (URL) or communication address of the MFP device is required because the MFP device may be included in the contacts list.

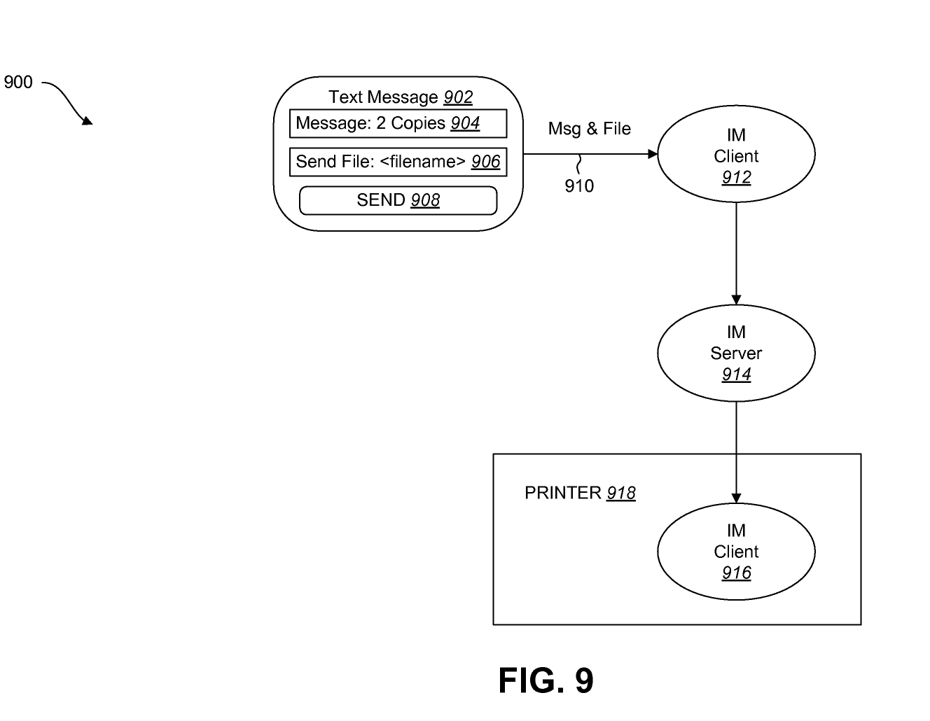

FIG. 9 is a flow diagram illustrating a method 900 for printing a print job using an IM application to submit the print job. A text message 902 (i.e., an instant message) may include a message area 904 and a send file area 906. A user may specify printer settings in the message area 904. For example, the user may specify “2 copies” in the message area 904 to indicate that two copies of a file should be printed. The text entered into the message area 904 may be in the syntax specified in the profile of the MFP device 918. Alternatively, the syntax may be specified in an initiation instant message sent from the MFP device 918. The user may also upload the file that is to be printed to the send file area 906. A send 908 button allows a user to send the instant message and uploaded file 910 to an IM client 912. The IM client 912 may be running on a computing device being used by the user. The IM client 912 sends the message 910 to an IM service 914 which forwards the message to an IM client 916 running on the MFP device 918.

Once the MFP device 918 has received the printer settings, the MFP device may send one or more additional instant messages back to the IM client used by the user to inform the user of the status of the print job. The instant messages sent from the MFP device may indicate that the document/settings were accepted for printing, the document has started printing, the document has finished printing and the status on any job interruption. Other instant messages may also be sent back and forth, such as the confirmation of the print settings and the payment method.

Other embodiments may include outbound imaging operations other than a print job, such as a fax or filing job. Further embodiments may include inbound imaging operations, such as a scan job. In addition, other embodiments may include other device web pages, such as for administration, status, etc.

While the present systems and methods discussed a print job as a direct submit, where the document has to be native to the printer (e.g., printer ready format), in other embodiments, the printer may provide conversion services for non-native formats.

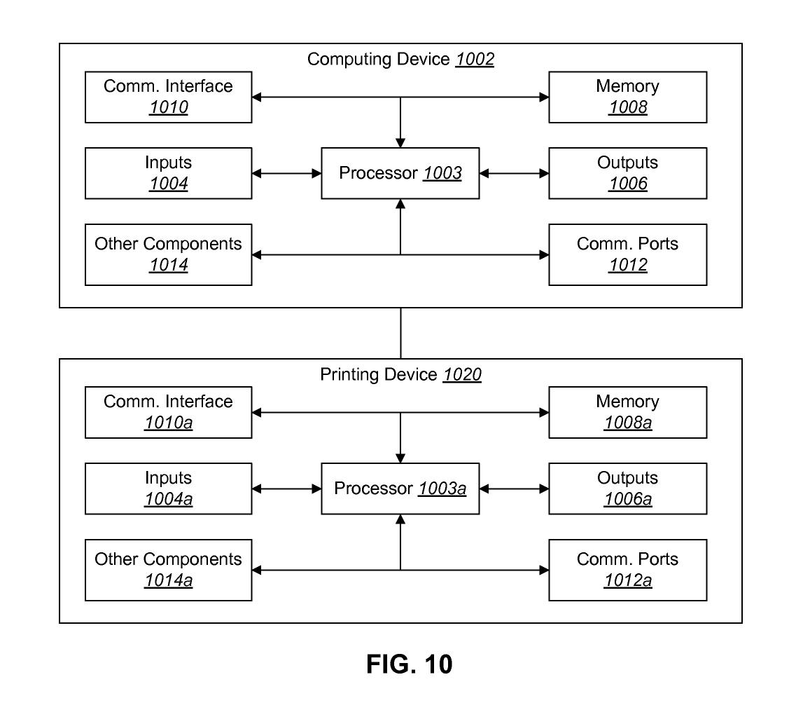

FIG. 10 is a block diagram illustrating the major hardware components typically utilized with embodiments herein. The systems and methods disclosed may be used with a computing device 1002 and a printing device 1020, imaging device or MFP. The major hardware components typically utilized in a computing device 1002 are illustrated in FIG. 10. A computing device 1002 typically includes a processor 1003 in electronic communication with input components or devices 1004 and/or output components or devices 1006. The processor 1003 is operably connected to input 1004 and/or output devices 1006 capable of electronic communication with the processor 1003, or, in other words, to devices capable of input and/or output in the form of an electrical signal. Embodiments of devices 1002 may include the inputs 1004, outputs 1006 and the processor 1003 within the same physical structure or in separate housings or structures.

The computing device 1002 may also include memory 1008. The memory 1008 may be a separate component from the processor 1003, or it may be on-board memory 1008 included in the same part as the processor 1003. For example, microcontrollers often include a certain amount of on-board memory.

The processor 1003 is also in electronic communication with a communication interface 1010. The communication interface 1010 may be used for communications with other devices 1002, printing devices 1020, servers, etc. Thus, the communication interfaces 1010 of the various devices 1002 may be designed to communicate with each other to send signals or messages between the computing devices 1002.

The computing device 1002 may also include other communication ports 1012. In addition, other components 1014 may also be included in the computing device 1002.

Many kinds of different devices may be used with embodiments herein. The computing device 1002 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 10 is only meant to illustrate typical components of a computing device 1002 and is not meant to limit the scope of embodiments disclosed herein.

The computing device 1002 is in electronic communication with the printing device 1020, imaging device or MFP. A printing device 1020 is a device that receives or transmits an imaging job, such as a Multi-Function Peripheral (“MFP”) or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, etc. A typical printing device, such as a physical printer, fax machine, scanner, multi-functional peripheral or copier is a type of computing device. As a result, it also includes a processor, memory, communications interface, etc., as shown and illustrated in relation to FIG. 10. The printing device may be a single or a plural grouping (e.g., pool or cluster) of two or more devices.

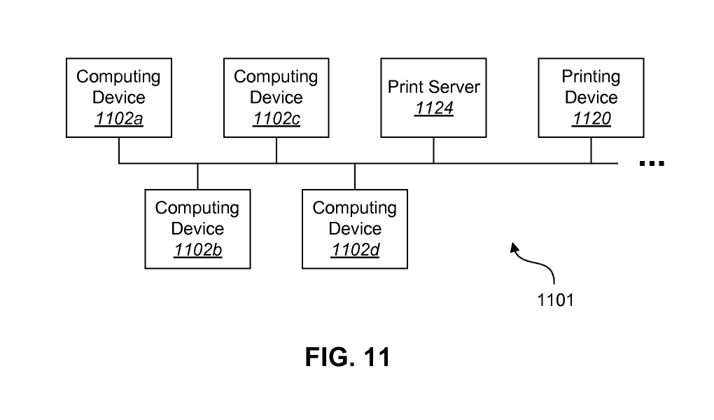

FIG. 11 is a network block diagram illustrating one possible environment in which the present systems and methods may be implemented. The present systems and methods may also be implemented on a standalone computer system. FIG. 11 illustrates a computer network 1101 comprising a plurality of computing devices 1102, a printing device 1120 and a print server 1124. The network 1101 may include a local-area network (LAN), a wide-area network (WAN), a campus-area network (CAN), a metropolitan-area network (MAN), a home-area network (HAN), a client/server network, a peer-to-peer network, an application-server network, the Internet, a paging network, a wireless network, a token ring network, an Ethernet network, etc.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A method for receiving a task via an instant messaging (IM) service, comprising:
connecting a device to the IM service;
receiving a task initiation instant message;
sending a response to the task initiation instant message, wherein the response includes instructions on how to send a task to the device using the IM service and wherein the instructions are independent of an IM provider that provides the IM service;
receiving a command to execute the task; and
executing the task at the device.

2. The method of claim 1, wherein the device is a Multi-Functional Printing (MFP) device.

3. The method of claim 1, further comprising registering the device with the IM service.

4. The method of claim 3, wherein registering the device comprises:
providing an email address assigned to the device; and
providing a unique user name assigned to the device.

5. The method of claim 1, further comprising receiving a request to add the device to a contact list.

6. The method of claim 1, wherein the response to the task initiation instant message comprises a hyper-text transfer protocol link to an embedded web page associated with the device.

7. The method of claim 6, further comprising submitting a document to print to the device over one or more firewalls via the embedded web page.

8. The method of claim 1, wherein the response to the task initiation instant message comprises instructions on how to upload a document to print to the device through the IM service.

9. The method of claim 1, wherein the response to the task initiation instant message comprises instructions on how to specify task settings in an instant message.

10. A method for sending a task via an Instant Messaging (IM) service, comprising:
sending a task initiation message to a device that is included in a contacts list; and
receiving a response to the task initiation message, wherein the response comprises an http link to a web page associated with the device and instructions on how to use the IM service for sending the task to the device and wherein the instructions are independent of an IM provider that provides the IM service.

11. The method of claim 10, further comprising uploading a file to be printed by the device through the IM service.

12. The method of claim 10, further comprising providing a textual description of settings for the task in an instant message.

13. The method of claim 10, further comprising sending an uploaded file to be printed and a textual description of settings for the task to the device through the IM service.

14. The method of claim 10, further comprising selecting the http link to request an embedded web page associated with the device.

15. The method of claim 10, further comprising submitting a file to be printed by the device and settings for the task via a web browser that displays an embedded web page associated with the device.

16. A printing device that is configured to receive a print job via an Instant Messaging (IM) service, the printing device comprising:
a processor;
memory in electronic communication with the processor;
instructions stored in the memory, the instructions being executable to:
connect the printing device to the IM service;
receive a print job initiation instant message;
send a response to the print job initiation instant message, wherein the response includes instructions on how to send a print job to the printing device using the IM service and wherein the instructions are independent of an IM provider that provides the IM service;
receive a command to execute the print job; and
execute the print job at the printing device.

17. The printing device of claim 16, wherein the printing device is a Multi-Functional Printing (MFP) device.

18. The printing device of claim 16, wherein the response to the print job initiation instant message comprises instructions on how to upload a document to print to the printing device through the IM service.

19. The printing device of claim 16, wherein the response to the print job initiation instant message comprises instructions on how to specify printer settings in an instant message.

20. A computer-readable medium comprising executable instructions for:
connecting a device to an Instant Messaging (IM) service;
receiving a task initiation instant message;
sending a response to the task initiation instant message, wherein the response includes instructions on how to send a task to the device using the IM service and wherein the instructions are independent of an IM provider that provides the IM service;
receiving a command to execute the task; and
executing the task at the device.
